(19) United States
(12) Patent Application Publication
(10) Pub. No.: US 2025/0374183 A1
(43) Pub. Date: Dec. 4, 2025

(54) RU APPARATUS, CONTROL APPARATUS, METHOD OF RU APPARATUS, AND METHOD OF CONTROL APPARATUS

(71) Applicant: NEC Corporation, Minato-ku, Tokyo (JP)

(72) Inventors: Atsushi NAKATA, Tokyo (JP); Ukyo HISHI, Tokyo (JP)

(73) Assignee: NEC Corporation, Minato-ku, Tokyo (JP)

(21) Appl. No.: 18/876,424

(22) PCT Filed: Jul. 11, 2023
(86) PCT No.: PCT/JP2023/025552

§ 371 Date: Dec. 18, 2024

(30) Foreign Application Priority Data
Jul. 27, 2022 (JP) 2022-119669

(51) Int. Cl. H04W 52/02; H04W 24/02

(52) U.S. Cl. CPC H04W 52/0206; H04W 24/02

(57) ABSTRACT

A control apparatus transmits a remote procedure call (RPC) message indicating retrieval (get or get-config) to an RU apparatus. The RU apparatus transmits an RPC reply (rpc-reply) message to the control apparatus in response to the RPC message. The RPC reply message includes, for example, information indicating stopping of a control/user (C/U)-plane of the RU apparatus in a case where a power-state of the RU apparatus is sleeping.

### TECHNICAL FIELD

The present disclosure relates to an RU apparatus, a control apparatus, a method of the RU apparatus, and a method of the control apparatus.

### BACKGROUND ART

In recent years, a radio access network has been used in which a baseband unit and a radio unit of a base station are separated and the baseband unit and the radio unit are connected via a front hole. The open-radio access network (O-RAN) fronthaul specification defined by the O-RAN Alliance defines the specification of a fronthaul between an O-RAN radio unit (O-RU) corresponding to the radio unit and an O-RAN distributed unit (O-DU) corresponding to the baseband unit. One object of the O-RAN fronthaul specification is to facilitate connection with an O-RU of a vendor different from a vendor of an O-DU, and to realize multi-vendor of a radio access network. Note that the O-DU may also be simply referred to as a DU. The O-RU may also be simply referred to as an RU.

Non Patent Literature 1 defines a specification related to a management (M)-Plane defined for transmitting management data between an O-RU and an O-DU. The M-Plane provides a management function for the O-RU. In the M-Plane, the O-DU or a service management and orchestration (SMO) is defined as an apparatus that manages the O-RU. The O-RU being a management target corresponds to a NETCONF server, and an apparatus (RU controller) that manages (controls) the O-RU corresponds to a NETCONF client. The M-Plane supports a protocol stack in which a signal used in a network configuration protocol (NETCONF) is transmitted in Ethernet/IP/TCP (Transmission Control Protocol)/SSH (Secure SHell) and, optionally, Ethernet/IP/TCP (Transmission Control Protocol)/TLS (Transport Layer Security) (see, for example, sections 9.1.2 and 9.1.3 of Non Patent Literature 1).

For example, Non Patent Literature 1 discloses a modification in a Power State of the O-RU. In a case where the Power State is AWAKE, the O-RU performs a normal operation (operation that is not in an energy saving mode), and in a case where the Power State is SLEEPING, the O-RU operates in the energy saving mode. The Power State of the O-DU is modified by the RU controller transmitting a remote procedure call (RPC) message indicating an edit-config to the O-DU.

### CITATION LIST

### Non Patent Literature

Non Patent Literature 1: O-RAN-WG4.MP.0-v09.00, “O-RAN Working Group 4 (Open Fronthaul Interfaces WG) Management Plane Specification”

### SUMMARY OF INVENTION

### Technical Problem

The inventor has studied specifications related to the M-Plane and found various problems. For example, Non Patent Literature 1 does not sufficiently study what state the RU specifically becomes (or may become), what processing is performed (or may be performed), and the like, in a case where the Power State of the RU becomes SLEEPING. In addition, Non Patent Literature 1 does not sufficiently study what processing RU specifically performs (or can perform), what processing needs to be performed, and the like, in a case where the Power State of RU changes from SLEEPING to AWAKE. In addition, Non Patent Literature 1 does not sufficiently study how a control apparatus can set the RU and the like in relation to these issues. Therefore, in the technology disclosed in Non Patent Literature 1, for example, there is a possibility that it is not possible to realize flexible control of the energy saving mode of the RU. This is also applied not only for the Power State of the RU, but also in a case where the value of an active parameter of tx/rx-array-carrier(s) of the RU is SLEEP or DISABLED. That is, in the technology disclosed in Non Patent Literature 1, for example, there is a possibility that it is not possible to realize flexible control of energy consumption of the RU.

An object of example embodiments disclosed in the present specification is to provide an RU apparatus and a control apparatus that contribute to solving at least one of a plurality of problems including the problems described above. Further, the object is merely one of a plurality of objects to be achieved by a plurality of example embodiments disclosed herein. The other objects or problems and novel features will be apparent from the description of the present specification or the accompanying drawings.

### Solution to Problem

According to an aspect, a radio unit (RU) apparatus includes
at least one memory; and
at least one processor coupled to the at least one memory.

The at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes any one or both of
information indicating that at least one of a control/user (C/U)-plane, a synchronization (S)-plane, a management (M)-plane, and components of the RU apparatus is stopped in a case where a power-state of the RU apparatus is sleeping, and
information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

According to another aspect, a radio unit (RU) apparatus includes
at least one memory; and
at least one processor coupled to the at least one memory.

The at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes any one or both of
information indicating whether or not a voltage of the RU apparatus can be lowered in a case where a power-state of the RU apparatus is sleeping, and
information indicating whether or not a voltage of the RU apparatus can be lowered in a case where a value of an active parameter of tx/rx-array-carriers of the RU apparatus is SLEEP or DISABLED.

According to still another aspect, a radio unit (RU) apparatus includes
at least one memory; and
at least one processor coupled to the at least one memory.

The at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes information indicating whether or not the RU apparatus transmits any one or both of Notification indicating that a state of tx/rx-array-carriers is Disabled in a case where a power-state of the RU apparatus is sleeping, and Notification indicating that the state of the tx/rx-array-carriers is Ready in a case where the power-state of the RU apparatus is Awake.

According to still yet another aspect, a radio unit (RU) apparatus includes
at least one memory; and
at least one processor coupled to the at least one memory.

The at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes information indicating that, in a case where a power-state of the RU apparatus is Awake, an active parameter of tx/rx-array-carriers needs to be reset to Active by the RU controller.

According to still yet another aspect, a control apparatus includes
at least one memory; and
at least one processor coupled to the at least one memory.

The at least one processor is configured to
transmit, to a radio unit (RU) apparatus, a remote procedure call (RPC) message that is based on a network configuration protocol (NETCONF) and indicates configuration edit (edit-config), and
the RPC message includes any one or both of
configuration information indicating that at least one of a control/user (C/U)-plane, a synchronization (S)-plane, a management (M)-plane, and components of the RU apparatus is stopped in a case where a power-state of the RU apparatus is sleeping, and
configuration information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

According to still yet another aspect, a control apparatus includes
at least one memory; and
at least one processor coupled to the at least one memory.

The at least one processor is configured to
transmit, to a radio unit (RU) apparatus, a remote procedure call (RPC) message that is based on a network configuration protocol (NETCONF) and indicates configuration edit (edit-config), and
the RPC message includes any one or both of
configuration information indicating that a voltage of the RU apparatus is lowered in a case where a power-state of the RU apparatus is sleeping, and
configuration information indicating that the voltage of the RU apparatus is lowered in a case where a value of an active parameter of tx/rx-array-carriers of the RU apparatus is SLEEP or DISABLED.

According to still yet another aspect, a method performed by a radio unit (RU) apparatus includes
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message.

The RPC reply message includes any one or both of
information indicating that at least one of a control/user (C/U)-plane, a synchronization (S)-plane, a management (M)-plane, and components of the RU apparatus is stopped in a case where a power-state of the RU apparatus is sleeping, and
information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

According to still yet another aspect, a method performed by a radio unit (RU) apparatus includes
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message.

The RPC reply message includes any one or both of
information indicating whether or not a voltage of the RU apparatus can be lowered in a case where a power-state of the RU apparatus is sleeping, and
information indicating whether or not a voltage of the RU apparatus can be lowered in a case where a value of an active parameter of tx/rx-array-carriers of the RU apparatus is SLEEP or DISABLED.

According to still yet another aspect, a method performed by a radio unit (RU) apparatus includes
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message.

The RPC reply message includes information indicating whether or not the RU apparatus transmits any one or both of Notification indicating that a state of tx/rx-array-carriers is Disabled in a case where a power-state of the RU apparatus is sleeping, and Notification indicating that the state of the tx/rx-array-carriers is Ready in a case where the power-state of the RU apparatus is Awake.

According to still yet another aspect, a method performed by a radio unit (RU) apparatus includes
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message.

The RPC reply message includes information indicating that, in a case where a power-state of the RU apparatus is Awake, an active parameter of tx/rx-array-carriers needs to be reset to Active by the RU controller.

According to still yet another aspect, a method performed by a control apparatus includes
transmitting, to a radio unit (RU) apparatus, a remote procedure call (RPC) message that is based on a network configuration protocol (NETCONF) and indicates configuration edit (edit-config).

The RPC message includes any one or both of
configuration information indicating that at least one of a control/user (C/U)-plane, a synchronization (S)-plane, a management (M)-plane, and components of the RU apparatus is stopped in a case where a power-state of the RU apparatus is sleeping, and
configuration information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

According to still yet another aspect, a method performed by a control apparatus includes
transmitting, to a radio unit (RU) apparatus, a remote procedure call (RPC) message that is based on a network configuration protocol (NETCONF) and indicates configuration edit (edit-config).

The RPC message includes any one or both of
configuration information indicating that a voltage of the RU apparatus is lowered in a case where a power-state of the RU apparatus is sleeping, and
configuration information indicating that the voltage of the RU apparatus is lowered in a case where a value of an active parameter of tx/rx-array-carriers of the RU apparatus is SLEEP or DISABLED.

### Advantageous Effects of Invention

The present disclosure can provide an RU apparatus, a control apparatus, a method of the RU apparatus, and a method of the control apparatus that contribute to solving at least one of a plurality of problems including the above-described problems.

### BRIEF DESCRIPTION OF DRAWINGS

FIG. 1 is a diagram illustrating an example of a retrieval procedure of a State of an RU.

FIG. 2 is a diagram illustrating an example of a modification procedure of the State of the RU.

FIG. 3 is a diagram for explaining a Power State of the RU.

FIG. 4 is a diagram illustrating possible transitions and a combination of an “active” parameter and a “state” parameter.

FIG. 5 is a diagram for explaining “Shared cell”.

FIG. 6 is a block diagram illustrating an example of a system.

FIG. 7 is a diagram illustrating an example of processing operations of an RU apparatus and a control apparatus in the present disclosure.

FIG. 8 is a diagram illustrating another example of the processing operations of the RU apparatus and the control apparatus in the present disclosure.

FIG. 9 is a diagram illustrating an example of a configuration of the control apparatus.

FIG. 10 is a diagram illustrating an example of a configuration of a DU apparatus.

FIG. 11 is a diagram illustrating an example of a configuration of the RU apparatus. FIG. 12 is a diagram illustrating an example of a configuration of an SMO apparatus.

### EXAMPLE EMBODIMENT

Hereinafter, example embodiments will be described with reference to the drawings. Note that, in the present disclosure, the drawings can be associated with one or more example embodiments. In addition, each element of the drawings can be applied to one or more example embodiments. In addition, in the example embodiments, the same or equivalent elements are denoted by the same reference signs, and repeated description will be omitted.

A plurality of example embodiments described below can be implemented independently or can be implemented in appropriate combination. The plurality of example embodiments have novel features different from each other. Thus, the plurality of example embodiments contribute to solving different objects or problems, and contribute to exhibiting different effects.

The example embodiments described below will be described by using, the main targets, an RU apparatus and a control apparatus according to an O-RAN technical specification. However, these example embodiments may be applied to other systems that support technologies similar to these RU apparatuses and control apparatus.

As used in the present specification, depending on the context, “if” may be interpreted to mean “when”, “at or around the time”, “after”, “upon”, “in response to determining”, “in accordance with a determination”, or “in response to detecting” These expressions may be interpreted to have the same meaning depending on the context.

First, the related art will be described. The individual example embodiments are based on these technologies. In other words, these technologies may be incorporated into individual example embodiments.

### Protocol

A control (C)-Plane is a protocol for transferring a control signal. A user (U)-Plane is a protocol for transferring user data. The C/U-Plane supports a protocol stack in which a signal used in eCPRI or radio over Ethernet (RoE) is directly transmitted by Ethernet and a protocol stack in which a signal is optionally transmitted via a user datagram protocol (UDP)/IP.

A synchronization (S)-Plane is a protocol for realizing synchronization between apparatuses. The S-Plane supports a protocol stack in which a signal used in a precision time protocol (PTP) and synchronous Ethernet (SyncE) is transmitted by Ethernet.

A management (M)-Plane is a protocol for handling a maintenance monitoring signal. The M-Plane supports a protocol stack in which a signal used in a network configuration protocol (NETCONF) is transmitted in Ethernet/IP/TCP (Transmission Control Protocol)/SSH (Secure SHell) and, optionally, Ethernet/IP/TCP (Transmission Control Protocol)/TLS (Transport Layer Security).

### Logical Architecture

The open-radio access network (O-RAN) alliance adopts a configuration in which a communication processing function of a RAN can be separated into three components of a radio unit (RU), a distributed unit (DU), and a central unit (CU). In addition, a “RAN intelligent controller (RIC)” which is a platform for realizing optimization of radio resource management and automation of operation, and a “service management and orchestration (SMO)” as a framework for performing maintenance and orchestration of the RAN are defined.

The RU and the DU are connected by an open fronthaul. A CUS/M-Plane signal is transmitted by the open fronthaul between the RU and the DU. Note that the RU and the SMO may be connected by the open fronthaul, and an M-Plane signal may be transmitted by the open fronthaul. Even in this case, the CUS-Plane signal is transmitted through the open fronthaul between the RU and the DU.

In addition, the DU and the SMO are connected by an Ol interface. In addition, the CU and the SMO are also connected by the O1 interface.

The RU being a management target corresponds to a NETCONF server, and a device (RU controller) that manages (controls) the RU corresponds to a NETCONF client. The NETCONF client may be disposed in the DU, or may be disposed in the SMO.

### Retrieval of State of RU

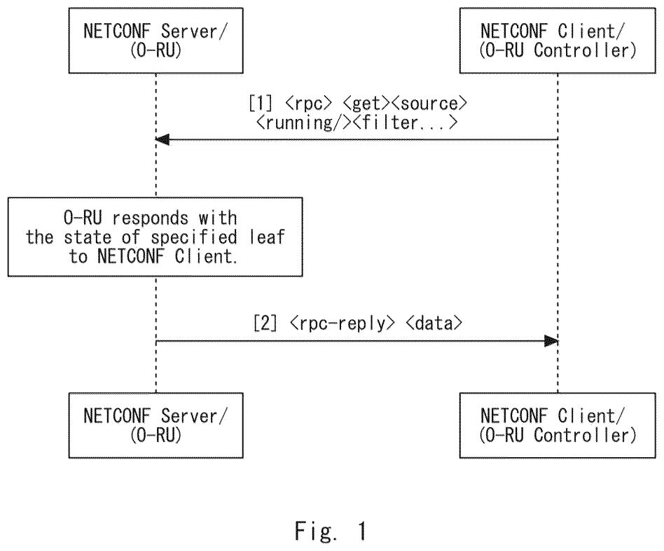

FIG. 1 is a diagram illustrating an example of a retrieval procedure of a State of an RU. In FIG. 1, an RU controller retrieves the state of the RU by using a NETCONF<get> procedure.

Specifically, the RU controller transmits a remote procedure call (RPC) message indicating retrieval (get) to the RU. The RU transmits an RPC reply (rpc-reply) message to the RU controller in response to the RPC message. The RPC reply message includes information indicating the State of the RU. That is, the RU controller can retrieve the State of the RU by a <get> request.

### Modification of State of RU

The RU controller may modify a configurable State of an RU that supports optional (selectable) hardware-state features defined in hardware of the RU. The RU controller can modify the configurable State of the RU by using a NETCONF<edit-config> procedure without reset.

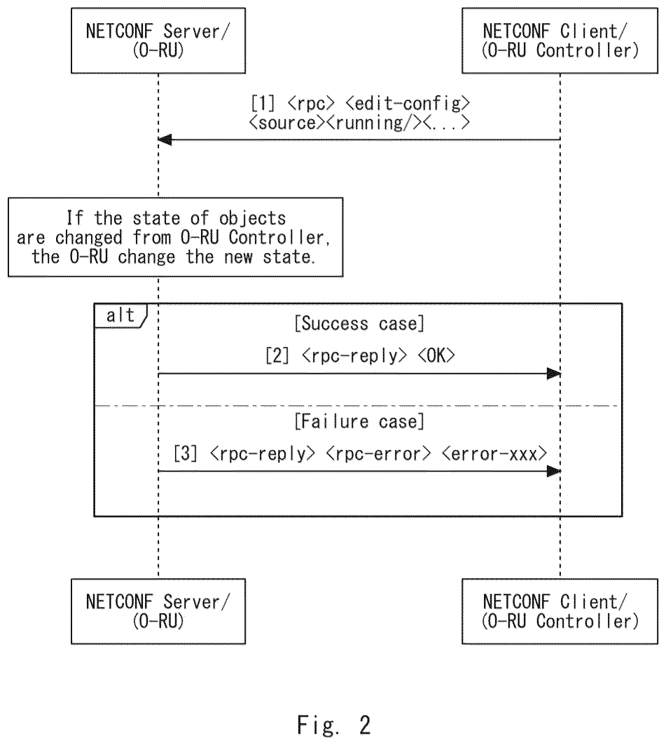

FIG. 2 is a diagram illustrating an example of the modification procedure of the State of the RU. The RU controller modifies the configurable State of the RU by using the NETCONF<edit-config> procedure without reset.

Specifically, the RU controller transmits, to the RU, an RPC message indicating configuration edit (edit-config). The RU modifies the own state based on this RPC message. Then, in a case where the modification is successful, the RU transmits an RPC reply message indicating <OK> to the RU controller.

[power-state]

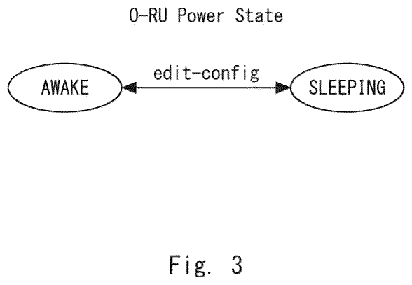

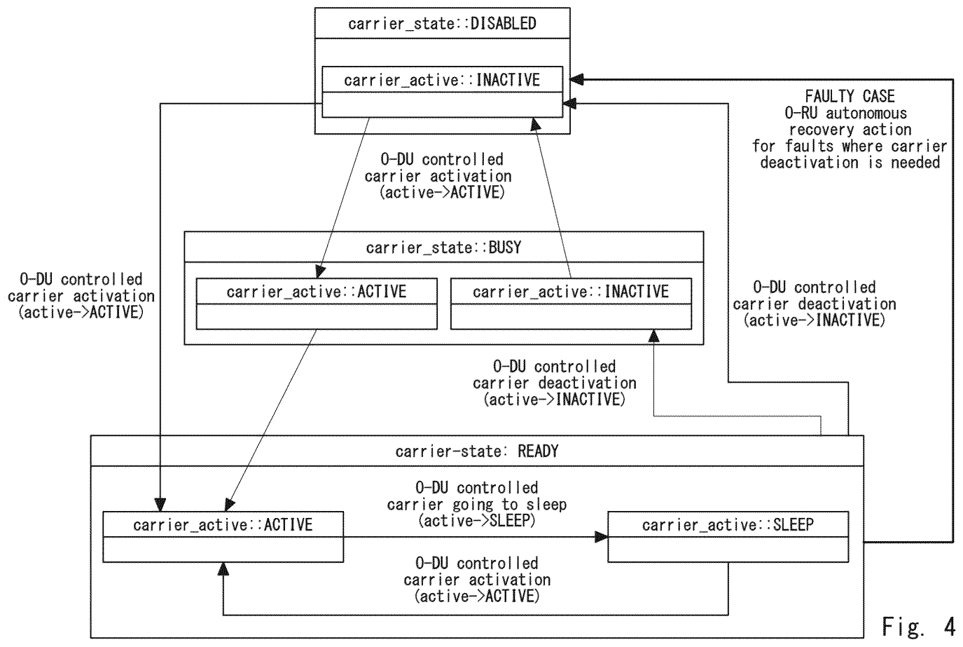

The configurable State of the RU is, for example, a power-state. As illustrated in FIG. 3, the Power State of the RU includes “AWAKE” and “SLEEPING”. FIG. 3 is a diagram for explaining the Power State of the RU. The RU controller can modify the Power State of the RU by using the NETCONF<edit-config> procedure. Specifically, the RU controller controls the Power State of the RU by transmitting an RPC message indicating configuration edit (edit-config) to the RU to edit an “energy-saving-enabled” parameter of the RU.
AWAKE: This Power State indicates that the RU is in normal operation, that is, is not in an Energy saving mode.
SLEEPING: This Power State indicates that the RU is in the Energy saving mode.

### Carrier Configuration of RU

The RU controller can set (update) the parameters of the RU by using the NETCONF<edit-config> procedure. For example, the RU controller performs activation by setting the value of an “active” parameter for a tx-array-carrier(s) element (and/or rx-array-carrier(s) element) to “ACTIVE”. In addition, the RU controller performs deactivation by setting the value of the “active” parameter for the tx-array-carrier(s) element (and/or rx-array-carrier(s) element) to “INACTIVE”. In addition, the RU controller sets the tx-array-carrier(s) element (and/or rx-array-carrier(s) element) to sleep by setting the value of the “active” parameter for the tx-array-carrier(s) element (and/or rx-array-carrier(s) element) to “SLEEP”. The tx-array-carrier(s) element (and/or rx-array-carrier(s) element) is in a sleep mode in a case where the value of the “active” parameter is “SLEEP” and the value of a “State” parameter is “READY”. FIG. 4 is a diagram illustrating possible transitions and a combination of the “active” parameter and the “state” parameter.

Here, the tx-array-carrier(s) is a data node that is generated by the RU controller and includes a carrier configuration parameter, and is associated with transmission array (tx-array) information of the RU. In addition, the rx-array-carrier(s) is a data node that is generated by the RU controller and includes a carrier configuration parameter, and is associated with reception array (rx-array) information of the RU. The tx-array-carrier(s) and the rx-array-carrier(s) are generated for each carrier and for each transmission/reception array, and the center frequency, the bandwidth, the transmission power, and the like of the carrier with respect to the RU are set.

### Shared Cell

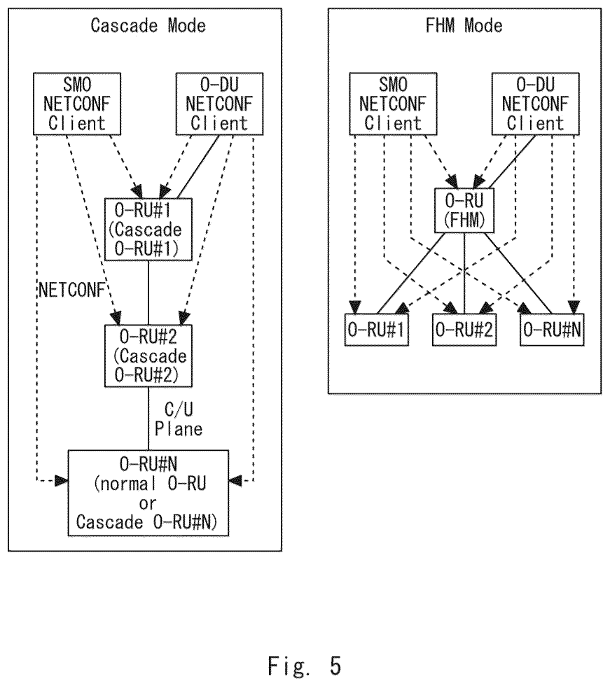

“Shared cell” is defined as an operation for the same cell (this cell may have one or a plurality of component carriers) by a plurality of RUs. FIG. 5 is a diagram for explaining “Shared cell”. As illustrated in FIG. 5, there are two approaches for realizing “Shared cell”. In FIG. 5, the solid line represents the C/U-plane, and the dotted line represents the M-plane.
FHM mode: In this mode, “Shared cell” is realized by a fronthaul multiplexer (FHM) and a plurality of RUs.
Cascade mode: In this mode, “Shared cell” is realized by cascade-connection (series) of a plurality of RUs.

In the Cascade mode, for a specific RU, an RU that is adjacent to the specific RU and closer to a DU (or SMO) than the specific RU may be referred to as a north-node. In addition, in the Cascade mode, for a DU or a specific RU, an adjacent RU farther from the DU may be referred to as a south-node.

### <Example of Configuration of System>

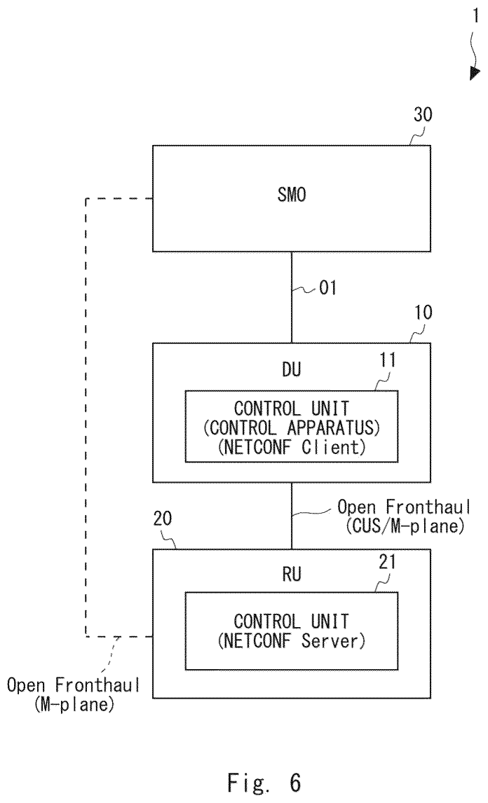

Next, an example of a configuration of a system common to a plurality of example embodiments will be described. FIG. 6 is a block diagram illustrating the example of the system. In FIG. 6, a system 1 includes a DU apparatus 10, an RU apparatus 20, and an SMO apparatus 30.

The DU apparatus 10 may be a logical node that executes functions in a packet data convergence protocol (PDCP) layer, a radio link control (RLC) layer, and a media access control (MAC) layer, and further a higher function of a physical layer, or may be a physical device on which the logical node is mounted. The higher function of the physical layer may be, for example, encoding and modulation processing, decoding and demodulation processing, and the like. The function in the PDCP layer may be executed in a logical node referred to as a central unit (CU) (not illustrated).

The RU apparatus 20 may be a logical node that executes a lower function (PHY-Low) of the physical layer and radio frequency (RF) processing, or may be a physical device on which the logical node is mounted. The lower function of the physical layer may be, for example, fast Fourier transform (FFT)/inverse FFT (IFFT) processing, beam forming (BF) processing, and the like.

The SMO apparatus 30 performs maintenance and orchestration of a radio access network (RAN) and a RAN intelligent controller (RIC) which is a platform for realizing optimization of radio resource management and automation of operation.

In FIG. 6, the DU apparatus 10 includes a control unit (control apparatus) 11. The control unit (control apparatus) 11 corresponds to a NETCONF client. The RU apparatus 20 includes a control unit 21. The RU apparatus 20 itself or the control unit 21 corresponds to a NETCONF server.

In addition, in FIG. 6, the DU apparatus 10 and the SMO apparatus 30 are connected via an O1 interface. In addition, the DU apparatus 10 and the RU apparatus 20 are connected via an open fronthaul. The open fronthaul can transmit a CUS-Plane signal and an M-Plane signal.

Note that the control unit (control apparatus) 11 (NETCONF client) may be provided in the SMO apparatus 30 instead of the DU apparatus 10. At this time, the RU apparatus 20 and the SMO apparatus 30 may also be connected by an open fronthaul. In this case, the open fronthaul connecting the DU apparatus 10 and the RU apparatus 20 transmits a CUS-Plane signal, while the open fronthaul connecting the RU apparatus 20 and the SMO apparatus 30 transmits an M-Plane signal.

### <First Example Embodiment>

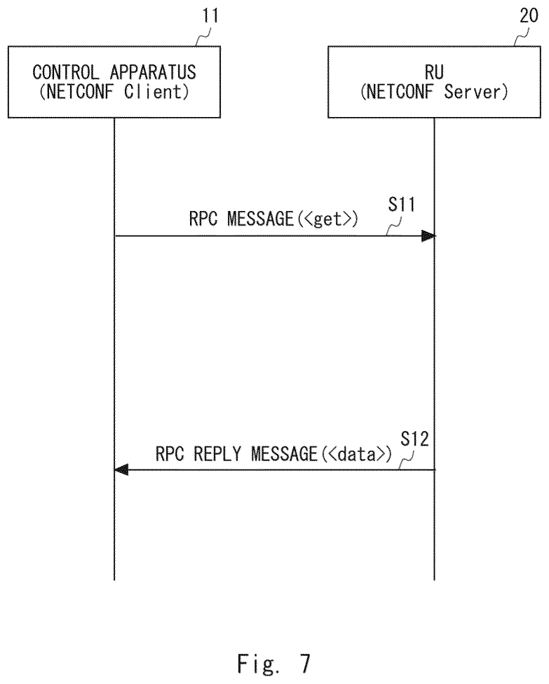

The configuration of a system in a first example embodiment may be the same as the example illustrated in FIG. 6. FIG. 7 is a diagram illustrating an example of processing operations of the RU apparatus and the control apparatus in the present disclosure.

The control apparatus 11 (NETCONF client) transmits a remote procedure call (RPC) message (may be referred to as a “first request message” below) indicating the retrieval (get) to the RU apparatus 20 (Step S11). The RU apparatus 20 transmits an RPC reply (rpc-reply) message (may be referred to as a “first reply message” below) to the control apparatus 11 in response to the first message (Step S12). That is, FIG. 7 illustrates an example of a processing operation of the RU apparatus 20 and the control apparatus 11 in accordance with the NETCONF<get>procedure. Note that the “first request message” may be a remote procedure call (RPC) message indicating retrieval (get-config).

The first request message may include, for example, “request information” indicating that the RU apparatus 20 is requested to transmit a first reply message including “request target information”. Furthermore, the request information may indicate a request for the entirety of an information set including a plurality of information elements, or may indicate a request for each information element. The request target information is “information regarding the RU apparatus 20”, and may be, for example, Capability information of the RU apparatus 20.

The RU apparatus 20 receives the first request message, and generates the first reply message including the request target information based on the request information of the first request message. For example, in a case where the request target information is Capability information of the RU apparatus 20, the first reply message includes the Capability information. Note that the “information regarding the RU apparatus 20” may be retrieved by the control apparatus 11 from the RU apparatus 20 during connection establishment between the RU apparatus 20 and the control apparatus 11 (in a part of an establishment procedure), for example, in addition to or instead of the NETCONF<get> procedure.

Next, a specific example of the “information regarding the RU apparatus 20” in the first example embodiment will be described. That is, the first message may include request information for any one or any combination (including all) of a plurality of information elements described below. In addition, the first reply message may include any one or any combination (including all) of a plurality of information elements described below based on the request information. Alternatively, the first reply message may include a part or all of the content related to any combination (including all) of a plurality of information elements described below based on the request information. Note that the capabilities or functions described below may be performed by the RU apparatus 20 autonomously or by the control apparatus 11 setting the RU apparatus 20.

### First Example of Information Element

The information element of a first example is Capability information indicating whether or not the RU apparatus 20 has a capability or a function of stopping the control/user (C/U)-plane of the RU apparatus 20 in a case where the power-state of the RU apparatus 20 is sleeping. That is, the information element of the first example is Capability information indicating whether or not the RU apparatus 20 has a capability or a function of stopping only the C/U-plane among the C/U-plane, the S-plane, and the M-plane of the RU apparatus 20 at this time.

### Second Example of Information Element

The information element of a second example is Capability information indicating whether or not the RU apparatus 20 has a capability or a function of stopping the synchronization (S)-plane of the RU apparatus 20 in a case where the power-state of the RU apparatus 20 is sleeping. That is, the information element of the second example is Capability information indicating whether or not the RU apparatus 20 has a capability or a function of stopping only the S-plane among the C/U-plane, the S-plane, and the M-plane of the RU apparatus 20 at this time.

### Third Example of Information Element

The information element of a third example is Capability information indicating whether or not the RU apparatus 20 has a capability or a function of stopping the management (M)-plane of the RU apparatus 20 in a case where the power-state of the RU apparatus 20 is sleeping. That is, the information element of the third example is Capability information indicating whether or not the RU apparatus 20 has a capability or a function of stopping only the M-plane among the C/U-plane, the S-plane, and the M-plane of the RU apparatus 20 at this time.

### Fourth Example of Information Element

The information element of a fourth example is Capability information indicating whether or not the RU apparatus 20 has a capability or a function of stopping a component of the RU apparatus 20 in a case where the power-state of the RU apparatus 20 is sleeping.

The component of the RU apparatus 20 may include any one or both of a digital device unit and an analog device unit. The digital device unit may include at least one of a field programmable gate array (FPGA), a complex programmable logic device (CPLD), an application specific integrated circuit (ASIC), a processor, and a network interface of the RU apparatus 20. In addition, the analog device unit may be a power amplifier (PA).

### Fifth Example of Information Element

The information element of a fifth example is Capability information indicating whether or not the RU apparatus 20 has a capability or a function of lowering a voltage of the RU apparatus 20 in a case where the power-state of the RU apparatus 20 is sleeping.

Lowering the voltage of the RU apparatus 20 may be, for example, at least one of “lowering the antenna transmission power of the RU apparatus 20”, “stopping a component of the RU apparatus 20”, and “stopping power supply from the RU apparatus 20 to an external device connected to the RU apparatus 20”. That is, the content of the above-described information element of the fourth example may be handled as a part of the information element of the fifth example.

The above-described “lowering the antenna transmission power of the RU apparatus 20” may mean autonomously lowering an antenna output to the minimum value of the antenna transmission power of the RU apparatus 20. The minimum value of the antenna transmission power of the RU apparatus 20 may be indicated by a “min-power-per-antenna” parameter of the module-capability.yang module from the RU apparatus 20 to the control apparatus 11.

The above-described “stopping the component of the RU apparatus 20” may be switching off the component of the RU apparatus 20.

The above-described “stopping power supply from the RU apparatus 20 to an external device connected to the RU apparatus 20” may mean an external device connected to an antenna line device (ALD) port of the RU apparatus 20. This external device may be an antenna tilt controller that controls the tilt of the antenna of the RU apparatus 20.

The information element of the first to fifth examples may indicate a unit of the function or the configuration that can be stopped by the RU apparatus 20 can be stopped (or of which an operation level can be reduced) in a case where the power-state of the RU apparatus 20 is sleeping, that is, in a case where the RU apparatus 20 is in the Energy saving mode. For example, there is a possibility that the function or configuration intended to be stopped (or to be stopped) is different depending on the position where the RU apparatus 20 exists in the “Shared cell” illustrated in FIG. 5 (for example, whether or not there is the south-node of the RU apparatus 20). For example, in a case where there is the south-node of the RU apparatus 20, there is a possibility that it is necessary to transfer the C/U-plane signal to the south-node even if the RU apparatus 20 is in the Energy saving mode. Therefore, there is a case where, even if the M-plane of the RU apparatus 20 can be stopped, it is better to set the C/U-plane in the “ACTIVE” state. Furthermore, if it takes time to establish synchronization, a case where it is better to set the S-plane to the “ACTIVE” state even if the RU apparatus 20 is in the Energy saving mode can be considered. Therefore, if the control apparatus 11 (NETCONF client) can retrieve the information element as in the first to fifth examples, the control apparatus 11 (NETCONF client) can more flexibly control the Energy saving mode of the RU apparatus 20.

### Sixth Example of Information Element

The information element of a sixth example is Capability information indicating whether or not the RU apparatus 20 has a capability or a function of stopping the control/user (C/U)-plane of the RU apparatus 20 in a case where the value of the active parameter of tx/rx-array-carrier(s) of the RU apparatus 20 is SLEEP or DISABLED. That is, the information element of the sixth example is Capability information indicating whether or not the RU apparatus 20 has a capability or a function of stopping only the C/U-plane among the C/U-plane, the S-plane, and the M-plane of the RU apparatus 20 at this time.

### Seventh Example of Information Element

The information element of a seventh example is Capability information indicating whether or not the RU apparatus 20 has a capability or a function of stopping the synchronization (S)-plane of the RU apparatus 20 in a case where the value of the active parameter of tx/rx-array-carrier(s) of the RU apparatus 20 is SLEEP or DISABLED. That is, the information element of the seventh example is Capability information indicating whether or not the RU apparatus 20 has a capability or a function of stopping only the S-plane among the C/U-plane, the S-plane, and the M-plane of the RU apparatus 20 at this time.

### Eighth Example of Information Element

The information element of an eighth example is Capability information indicating whether or not the RU apparatus 20 has a capability or a function of stopping the management (M)-plane of the RU apparatus 20 in a case where the value of the active parameter of tx/rx-array-carrier(s) of the RU apparatus 20 is SLEEP or DISABLED. That is, the information element of the eighth example is Capability information indicating whether or not the RU apparatus 20 has a capability or a function of stopping only the M-plane among the C/U-plane, the S-plane, and the M-plane of the RU apparatus 20 at this time.

### Ninth Example of Information Element

The information element of a ninth example is Capability information indicating whether or not the RU apparatus 20 has a capability or a function of stopping the component of the RU apparatus 20 in a case where the value of the active parameter of tx/rx-array-carrier(s) of the RU apparatus 20 is SLEEP or DISABLED.

The component of the RU apparatus 20 may include at least one of the digital device unit and the analog device unit. The digital device unit may include at least one of a field programmable gate array (FPGA), a complex programmable logic device (CPLD), an application specific integrated circuit (ASIC), a processor, and a network interface of the RU apparatus 20. In addition, the analog device unit may be a power amplifier (PA).

### Tenth Example of Information Element

The information element of a tenth example is Capability information indicating whether or not the RU apparatus 20 has a capability or a function of lowering the voltage of the RU apparatus 20 in a case where the value of the active parameter of tx/rx-array-carrier(s) of the RU apparatus 20 is SLEEP or DISABLED.

Lowering the voltage of the RU apparatus 20 may be, for example, at least one of “lowering the antenna transmission power of the RU apparatus 20”, “stopping a component of the RU apparatus 20”, and “stopping power supply from the RU apparatus 20 to an external device connected to the RU apparatus 20”. That is, the content of the above-described information element of the ninth example may be handled as a part of the information element of the tenth example.

The above-described “lowering the antenna transmission power of the RU apparatus 20” may mean autonomously lowering an antenna output to the minimum value of the antenna transmission power of the RU apparatus 20. The minimum value of the antenna transmission power of the RU apparatus 20 may be indicated by a “min-power-per-antenna” parameter of the module-capability. yang module from the RU apparatus 20 to the control apparatus 11.

The above-described “stopping the component of the RU apparatus 20” may be switching off the component of the RU apparatus 20.

The above-described “stopping power supply from the RU apparatus 20 to an external device connected to the RU apparatus 20” may mean an external device connected to an antenna line device (ALD) port of the RU apparatus 20. This external device may be an antenna tilt controller that controls the tilt of the antenna of the RU apparatus 20.

The information element of the sixth to tenth examples may indicate a unit of the function or the configuration that can be stopped by the RU apparatus 20 (or of which the operation level can be reduced) in a case where the value of the active parameter of tx/rx-array-carrier(s) of the RU apparatus 20 is SLEEP or DISABLED. For example, there is a possibility that the function or configuration intended to be stopped (or to be stopped) is different depending on the position where the RU apparatus 20 exists in the “Shared cell” illustrated in FIG. 5 (for example, whether or not there is the south-node of the RU apparatus 20). For example, in a case where there is the south-node of the RU apparatus 20, there is a possibility that it is necessary to transfer the C/U-plane signal to the south-node even if the value of the active parameter of tx/rx-array-carrier(s) of the RU apparatus 20 is SLEEP or DISABLED. Therefore, there is a case where, even if the M-plane of the RU apparatus 20 can be stopped, it is better to set the C/U-plane in the “ACTIVE” state. In addition, if it takes time to establish synchronization, a case where it is better to set the S-plane to the “ACTIVE” state even if the value of the active parameter of tx/rx-array-carrier(s) of the RU apparatus 20 is SLEEP or DISABLED can be considered. Therefore, if the control apparatus 11 (NETCONF client) can retrieve the information element as in the sixth to tenth examples, the control apparatus 11 (NETCONF client) can more flexibly control the energy consumption of the RU apparatus 20.

### Eleventh Example of Information Element

tx-array-carrier(s) (and/or rx-array-carrier(s)) may be collectively referred to as “tx/rx-array-carrier(s)” below. The information element of an eleventh example is information indicating whether or not the RU apparatus 20 sends a Notification indicating that the value of the “state” parameter of tx/rx-array-carrier(s) is “Disabled” in a case where the power-state of the RU apparatus 20 is sleeping.

The control apparatus 11 (NETCONF client) retrieves the information element of the eleventh example, so that the control apparatus 11 can ascertain “whether or not to receive, from the RU apparatus 20, a Notification indicating that the value of the “state” parameter of tx/rx-array-carrier(s) is “Disabled” in a case where the power-state of the RU apparatus 20 is set from Awake to sleeping”. By receiving this Notification, the control apparatus 11 can ascertain the “state” parameter of tx/rx-array-carrier(s) in the RU apparatus 20.

### Twelfth Example of Information Element

The information element of a twelfth example is information indicating whether or not the RU apparatus 20 sends a Notification indicating that the value of the “state” parameter of tx/rx-array-carrier(s) is “Ready” in a case where the power-state of the RU apparatus 20 is Awake.

The control apparatus 11 (NETCONF client) retrieves the information element of the twelfth example, so that the control apparatus 11 can ascertain “whether or not to receive, from the RU apparatus 20, a Notification indicating that the value of the “state” parameter of tx/rx-array-carrier(s) is “Ready” in a case where the power-state of the RU apparatus 20 is set from sleeping to Awake”. By receiving this Notification, the control apparatus 11 can ascertain the “state” parameter of tx/rx-array-carrier(s) in the RU apparatus 20.

### Thirteenth Example of Information Element

The information element of a thirteenth example is information indicating that the value of the “active” parameter of tx/rx-array-carrier(s) needs to be reset to “Active” by the control apparatus 11 (NETCONF client) in a case where the power-state of the RU apparatus 20 is Awake.

The control apparatus 11 (NETCONF client) retrieves the information element of the thirteenth example, so that the control apparatus 11 can ascertain “the control apparatus 11 needs to reset the value of the “active” parameter of tx/rx-array-carrier(s) to “Active” in a case where the power-state of the RU apparatus 20 is changed from sleeping to Awake”. As a result, in a case where performing control to change the power-state of the RU apparatus 20 from sleeping to Awake, the control apparatus 11 (NETCONF client) can also perform control to reset the value of the “active” parameter of tx/rx-array-carrier(s) to “Active” in addition to this control.

As described above, according to the first example embodiment, the RU apparatus 20 transmits the RPC reply (rpc-reply) message to the control apparatus 11 in response to the remote procedure call (RPC) message indicating the retrieval (get or get-config). The RPC reply message includes information regarding the RU apparatus 20.

This “information regarding the RU apparatus 20” may include information regarding the function or the configuration that can be stopped by the RU apparatus 20 (or of which the operation level can be reduced) in a case where the power-state of the RU apparatus 20 is sleeping. This information may include, for example, any one or any combination (including all) of the information elements of the first to fifth examples described above. Alternatively, this information may include a part or the entirety of the content related to any combination (including all) of the information elements of the first to fifth examples described above.

With the configuration of the RU apparatus 20, the control apparatus 11 (NETCONF client) can more flexibly control the Energy saving mode of the RU apparatus 20. That is, it is possible to realize flexible control of the energy consumption of the RU apparatus 20.

In addition, “the information regarding the RU apparatus 20” may include information regarding the function or the configuration that can be stopped by the RU apparatus 20 (or of which the operation level can be reduced) in a case where the value of the active parameter of tx/rx-array-carrier(s) of the RU apparatus 20 is SLEEP or DISABLED. This information may include, for example, any one or any combination (including all) of the information elements of the sixth to tenth examples described above. Alternatively, this information may include a part or the entirety of the content related to any combination (including all) of the information elements of the sixth to tenth examples described above.

With this configuration of the RU apparatus 20, the control apparatus 11 (NETCONF client) can more flexibly control the energy consumption of the RU apparatus 20.

Furthermore, the “information regarding the RU apparatus 20” may include information regarding a Notification indicating the “state” parameter of tx/rx-array-carrier(s) corresponding to the power-state of the RU apparatus 20. This information may be, for example, any one or both of the information elements of the eleventh and twelfth examples described above.

With the configuration of the RU apparatus 20, it is possible to ascertain whether the control apparatus 11 (NETCONF client) can receive a notification indicating the “state” parameter of tx/rx-array-carrier(s) in association with switching of the Energy saving mode of the RU apparatus 20. As a result, the control apparatus 11 (NETCONF client) can more flexibly control the Energy saving mode of the RU apparatus 20. That is, it is possible to realize flexible control of the energy consumption of the RU apparatus 20.

In addition, the “information regarding the RU apparatus 20” may include information indicating that the value of the “active” parameter of tx/rx-array-carrier(s) needs to be reset to “Active” by the control apparatus 11 (NETCONF client) in a case where the power-state of the RU apparatus 20 is Awake.

With the configuration of the RU apparatus 20, the control apparatus 11 can ascertain that “the control apparatus 11 needs to reset the value of the “active” parameter of tx/rx-array-carrier(s) to “Active” in a case where the power-state of the RU apparatus 20 is changed from sleeping to Awake”. As a result, in a case where performing control to change the power-state of the RU apparatus 20 from sleeping to Awake, the control apparatus 11 (NETCONF client) can also perform control to reset the value of the “active” parameter of tx/rx-array-carrier(s) to “Active” in addition to this control. That is, the control apparatus 11 (NETCONF client) can more flexibly control the Energy saving mode of the RU apparatus 20. That is, it is possible to realize flexible control of the energy consumption of the RU apparatus 20.

### <Second Example Embodiment>

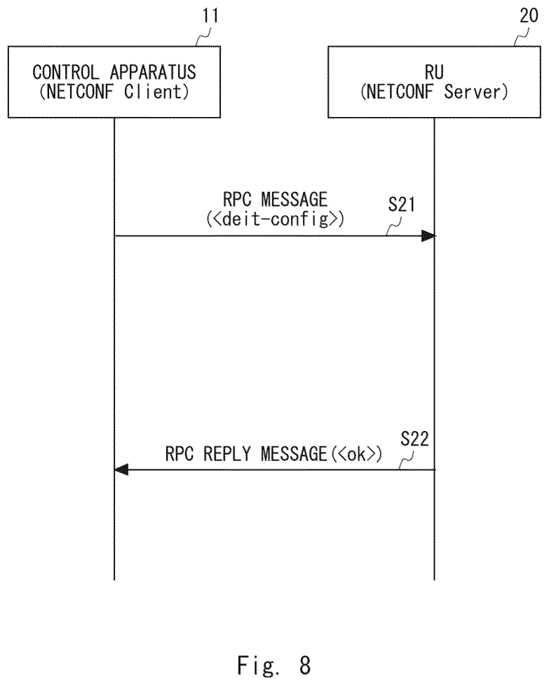

The configuration of a system in a second example embodiment may be the same as the example illustrated in FIG. 6. FIG. 8 is a diagram illustrating another example of processing operations of the RU apparatus and the control apparatus in the present disclosure.

The control apparatus 11 (NETCONF client) transmits an RPC message (may be referred to as a “second request message” below) indicating configuration edit (edit-config) to the RU apparatus 20 (Step S21). The RU apparatus 20 transmits an RPC reply (rpc-reply) message (may be referred to as a “second reply message” below) to the control apparatus 11 in response to the second message (Step S22). That is, FIG. 8 illustrates an example of a processing operation of the RU apparatus 20 and the control apparatus 11 in accordance with the NETCONF<edit-config>procedure.

The second request message may include “configuration information” indicating a control target and the control content for the control target, for example.

The RU apparatus 20 sets (updates) the parameters of the RU apparatus 20 based on the configuration information included in the second request message. For example, if the configuration information indicates stopping the C/U-plane, the RU apparatus 20 stops the C/U-plane. Then, in a case where the configuration based on the configuration information is successful, the RU apparatus 20 may transmit a second reply message indicating <OK> to the control apparatus 11. In addition, in a case where the configuration based on the configuration information has failed, the RU apparatus 20 may transmit a second reply message indicating <error>to the control apparatus 11.

Next, a specific example of a “configuration information element” in the second example embodiment will be described. That is, the second message may include, as the configuration information, any one or any combination (including all) of a plurality of configuration information elements described below. Alternatively, the second message may include a part or all of the content related to any combination (including all) of a plurality of configuration information elements described below.

### First Example of Configuration Information Element

The configuration information element of a first example is configuration information indicating that the C/U-plane is stopped in a case where the power-state of the RU apparatus 20 is sleeping. For example, the configuration information element of the first example is used as a pair with the Capability information of the “information element of the first example” described in the first example embodiment. That is, the configuration information element of the first example may be transmitted in a case where the RU apparatus 20 has the capability or function corresponding to the configuration.

### Second Example of Configuration Information Element

The configuration information element of a second example is configuration information indicating that the S-plane is stopped in a case where the power-state of the RU apparatus 20 is sleeping. For example, the configuration information element of the second example is used as a pair with the Capability information of the “information element of the second example” described in the first example embodiment. That is, the configuration information element of the second example may be transmitted in a case where the RU apparatus 20 has the capability or function corresponding to the configuration.

### Third Example of Configuration Information Element

The configuration information element of a third example is configuration information indicating that the M-plane is stopped in a case where the power-state of the RU apparatus 20 is sleeping. For example, the configuration information element of the third example is used as a pair with the Capability information of the “information element of the third example” described in the first example embodiment. That is, the configuration information element of the third example may be transmitted in a case where the RU apparatus 20 has the capability or function corresponding to the configuration.

### Fourth Example of Configuration Information Element

The configuration information element of a fourth example is configuration information indicating that the component of the RU apparatus 20 is stopped in a case where the power-state of the RU apparatus 20 is sleeping. For example, the configuration information element of the fourth example is used as a pair with the Capability information of the “information element of the fourth example” described in the first example embodiment. That is, the configuration information element of the fourth example may be transmitted in a case where the RU apparatus 20 has the capability or function corresponding to the configuration.

The component of the RU apparatus 20 may include any one or both of a digital device unit and an analog device unit. The digital device unit may include at least one of a field programmable gate array (FPGA), a complex programmable logic device (CPLD), an application specific integrated circuit (ASIC), a processor, and a network interface of the RU apparatus 20. In addition, the analog device unit may be a power amplifier (PA).

### Fifth Example of Configuration Information Element

The configuration information element of a fifth example is configuration information indicating that the voltage of the RU apparatus 20 is lowered in a case where the power-state of the RU apparatus 20 is sleeping. For example, the configuration information element of the fifth example is used as a pair with the Capability information of the “information element of the fifth example” described in the first example embodiment. That is, the configuration information element of the fifth example may be transmitted in a case where the RU apparatus 20 has the capability or function corresponding to the configuration.

Lowering the voltage of the RU apparatus 20 may be, for example, at least one of “lowering the antenna transmission power of the RU apparatus 20”, “stopping a component of the RU apparatus 20”, and “stopping power supply from the RU apparatus 20 to an external device connected to the RU apparatus 20”. That is, the content of the above-described configuration information element of the fourth example may be handled as a part of the configuration information element of the fifth example.

The above-described “lowering the antenna transmission power of the RU apparatus 20” may mean autonomously lowering an antenna output to the minimum value of the antenna transmission power of the RU apparatus 20. The minimum value of the antenna transmission power of the RU apparatus 20 may be indicated by a “min-power-per-antenna” parameter of the module-capability.yang module from the RU apparatus 20 to the control apparatus 11.

The above-described “stopping the component of the RU apparatus 20” may be switching off the component of the RU apparatus 20.

The above-described “stopping power supply from the RU apparatus 20 to an external device connected to the RU apparatus 20” may mean an external device connected to an antenna line device (ALD) port of the RU apparatus 20. This external device may be an antenna tilt controller that controls the tilt of the antenna of the RU apparatus 20.

The configuration information element of the first to fifth examples may indicate a unit of the function or the configuration which is caused to be stopped by the RU apparatus 20 (or caused to reduce the operation level) in a case where the power-state of the RU apparatus 20 is sleeping, that is, in a case where the RU apparatus 20 is in the Energy saving mode. For example, there is a possibility that the function or configuration intended to be stopped (or to be stopped) is different depending on the position where the RU apparatus 20 exists in the “Shared cell” illustrated in FIG. 5 (for example, whether or not there is the south-node of the RU apparatus 20). For example, in a case where there is the south-node of the RU apparatus 20, there is a possibility that it is necessary to transfer the C/U-plane signal to the south-node even if the RU apparatus 20 is in the Energy saving mode. Therefore, there is a case where, even if the M-plane of the RU apparatus 20 can be stopped, it is better to set the C/U-plane in the “ACTIVE” state. Furthermore, if it takes time to establish synchronization, a case where it is better to set the S-plane to the “ACTIVE” state even if the RU apparatus 20 is in the Energy saving mode can be considered. Therefore, by transmitting the configuration information element as in the first to fifth examples to the RU apparatus 20 and controlling the RU apparatus 20, the control apparatus 11 can more flexibly control the Energy saving mode of the RU apparatus 20.

### Sixth Example of Configuration Information Element

The configuration information element of a sixth example is configuration information indicating that the C/U-plane is stopped in a case where the value of the active parameter of tx/rx-array-carrier(s) of the RU apparatus 20 is SLEEP or DISABLED. For example, the configuration information element of the sixth example is used as a pair with the Capability information of the “information element of the sixth example” described in the first example embodiment. That is, the configuration information element of the sixth example may be transmitted in a case where the RU apparatus 20 has the capability or function corresponding to the configuration.

### Seventh Example of Configuration Information Element

The configuration information element of a seventh example is configuration information indicating that the S-plane is stopped in a case where the value of the active parameter of tx/rx-array-carrier(s) of the RU apparatus 20 is SLEEP or DISABLED. For example, the configuration information element of the seventh example is used as a pair with the Capability information of the “information element of the seventh example” described in the first example embodiment. That is, the configuration information element of the seventh example may be transmitted in a case where the RU apparatus 20 has the capability or function corresponding to the configuration.

### Eighth Example of Configuration Information Element

The configuration information element of an eighth example is configuration information indicating that the M-plane is stopped in a case where the value of the active parameter of tx/rx-array-carrier(s) of the RU apparatus 20 is SLEEP or DISABLED. For example, the configuration information element of the eighth example is used as a pair with the Capability information of the “information element of the eighth example” described in the first example embodiment. That is, the configuration information element of the eighth example may be transmitted in a case where the RU apparatus 20 has the capability or function corresponding to the configuration.

### Ninth Example of Configuration Information Element

The configuration information element of a ninth example is configuration information indicating that the component of the RU apparatus 20 is stopped in a case where the value of the active parameter of tx/rx-array-carrier(s) of the RU apparatus 20 is SLEEP or DISABLED. For example, the configuration information element of the ninth example is used as a pair with the Capability information of the “information element of the ninth example” described in the first example embodiment. That is, the configuration information element of the ninth example may be transmitted in a case where the RU apparatus 20 has the capability or function corresponding to the configuration.

The component of the RU apparatus 20 may include any one or both of a digital device unit and an analog device unit. The digital device unit may include at least one of a field programmable gate array (FPGA), a complex programmable logic device (CPLD), an application specific integrated circuit (ASIC), a processor, and a network interface of the RU apparatus 20. In addition, the analog device unit may be a power amplifier (PA).

### Tenth Example of Configuration Information Element

The configuration information element of a tenth example is configuration information indicating that the voltage of the RU apparatus 20 is lowered in a case where the value of the active parameter of tx/rx-array-carrier(s) of the RU apparatus 20 is SLEEP or DISABLED. For example, the configuration information element of the tenth example is used as a pair with the Capability information of the “information element of the tenth example” described in the first example embodiment. That is, the configuration information element of the tenth example may be transmitted in a case where the RU apparatus 20 has the capability or function corresponding to the configuration.

Lowering the voltage of the RU apparatus 20 may be, for example, at least one of “lowering the antenna transmission power of the RU apparatus 20”, “stopping a component of the RU apparatus 20”, and “stopping power supply from the RU apparatus 20 to an external device connected to the RU apparatus 20”. That is, the content of the above-described configuration information element of the ninth example may be handled as a part of the configuration information element of the tenth example.

The above-described “lowering the antenna transmission power of the RU apparatus 20” may mean autonomously lowering an antenna output to the minimum value of the antenna transmission power of the RU apparatus 20. The minimum value of the antenna transmission power of the RU apparatus 20 may be indicated by a “min-power-per-antenna” parameter of the module-capability.yang module from the RU apparatus 20 to the control apparatus 11.

The above-described “stopping the component of the RU apparatus 20” may be switching off the component of the RU apparatus 20.

The above-described “stopping power supply from the RU apparatus 20 to an external device connected to the RU apparatus 20” may mean an external device connected to an antenna line device (ALD) port of the RU apparatus 20. This external device may be an antenna tilt controller that controls the tilt of the antenna of the RU apparatus 20.

The configuration information element of the sixth to tenth examples may indicate a unit of the function or the configuration which is caused to be stopped by the RU apparatus 20 (or caused to reduce the operation level) in a case where the value of the active parameter of tx/rx-array-carrier(s) of the RU apparatus 20 is SLEEP or DISABLED. For example, there is a possibility that the function or configuration intended to be stopped (or to be stopped) is different depending on the position where the RU apparatus 20 exists in the “Shared cell” illustrated in FIG. 5 (for example, whether or not there is the south-node of the RU apparatus 20). For example, in a case where there is the south-node of the RU apparatus 20, there is a possibility that it is necessary to transfer the C/U-plane signal to the south-node even if the value of the active parameter of tx/rx-array-carrier(s) of the RU apparatus 20 is SLEEP or DISABLED. Therefore, there is a case where, even if the M-plane of the RU apparatus 20 can be stopped, it is better to set the C/U-plane in the “ACTIVE” state. In addition, if it takes time to establish synchronization, a case where it is better to set the S-plane to the “ACTIVE” state even if the value of the active parameter of tx/rx-array-carrier(s) of the RU apparatus 20 is SLEEP or DISABLED can be considered. Therefore, by transmitting the configuration information element as in the sixth to tenth examples to the RU apparatus 20 and controlling the RU apparatus 20, the control apparatus 11 can more flexibly control the energy consumption of the RU apparatus 20.

As described above, according to the second example embodiment, the control apparatus 11 transmits the RPC message indicating the configuration edit (edit-config) to the RU apparatus 20.

The RPC message may include “configuration information” indicating the control target in the RU apparatus 20 and the control content for the control target in a case where the power-state of the RU apparatus 20 is sleeping. This configuration information may include any one or any combination (including all) of the configuration information elements of the first to fifth examples described above. Alternatively, this information may include a part or the entirety of the content related to any combination (including all) of the configuration information elements of the first to fifth examples described above.

With this configuration of the control apparatus 11, it is possible to more flexibly control the Energy saving mode of the RU apparatus 20. That is, it is possible to realize flexible control of the energy consumption of the RU apparatus 20.

Furthermore, the RPC message may include “configuration information” indicating the control target in the RU apparatus 20 and the control content for the control target in a case where the value of the active parameter of tx/rx-array-carrier(s) of the RU apparatus 20 is SLEEP or DISABLED. This configuration information may include any one or any combination (including all) of the configuration information elements of the sixth to tenth examples described above. Alternatively, this information may include a part or the entirety of the content related to any combination (including all) of the configuration information elements of the sixth to tenth examples described above.

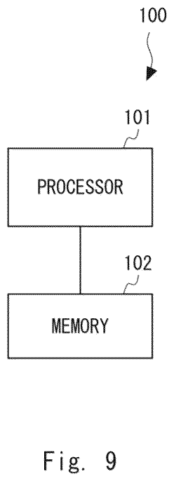

### <Other Example Embodiments>

<1> FIG. 9 is a diagram illustrating an example of the configuration of the control apparatus. In FIG. 9, a control apparatus 100 includes a processor 101 and a memory 102. The control apparatus 11 may have a configuration illustrated in FIG. 9. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a plurality of physically independent memory devices. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 102 may include a storage located away from the processor 101. In this case, the processor 101 may access the memory 102 through an input (I)/output (O) interface (not illustrated).

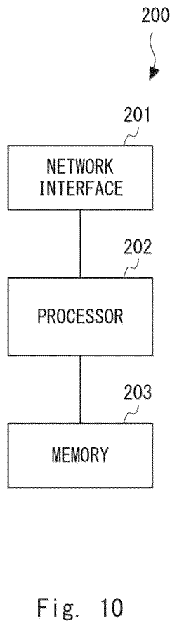

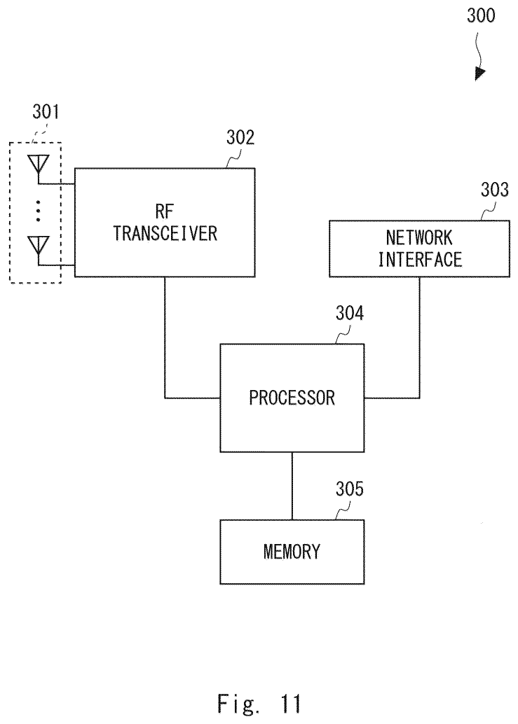

The memory 102 may store one or more software module (computer program) including a group of instructions and data for performing processing by the control apparatus 11 described in the example embodiments as described above. In some implementations, the processor 101 may be configured to perform the processing of the control apparatus 11 described in the example embodiments as described above by reading and executing the software module from the memory 102.

<2> FIG. 10 is a diagram illustrating a configuration example of the DU apparatus. In FIG. 10, an apparatus 200 includes a network interface 201, a processor 202, and a memory 203. The DU apparatus 10 may have a configuration illustrated in FIG. 10.

The network interface 201 is used, for example, to communicate with a network element (for example, the SMO apparatus 30, and other RAN nodes). The network interface 1201 may include, for example, a network interface card (NIC) conforming to IEEE 802.3 series.

The processor 202 may be, for example, a microprocessor, an MPU, or a CPU. The processor 202 may include a plurality of processors.

The memory 203 is constituted by a volatile memory and a nonvolatile memory. The memory 203 may include a plurality of physically independent memory devices. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 203 may include a storage located away from the processor 202. In this case, the processor 202 may access the memory 203 through the network interface 201 or an I/O interface.

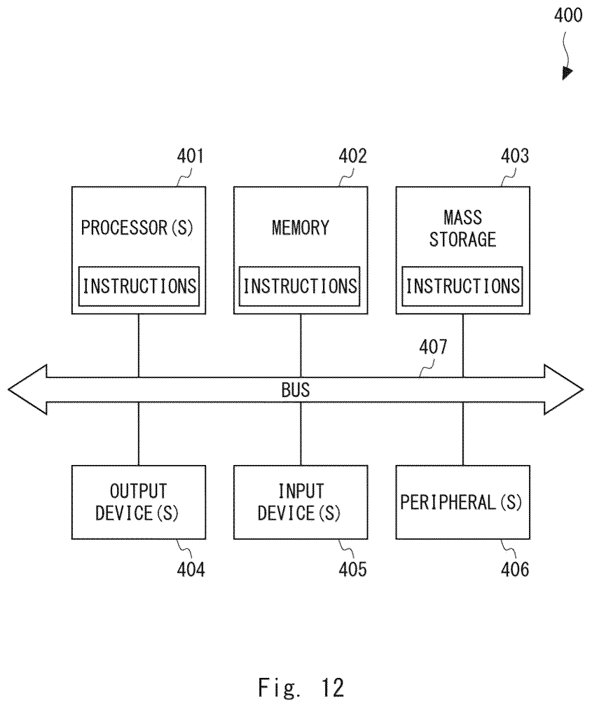

The memory 203 may store one or more software module (computer program) including a group of instructions and data for performing processing by the DU apparatus 10 described in the example embodiments as described above. In some implementations, the processor 202 may be configured to perform the processing of the DU apparatus 10 described in the example embodiments as described above by reading and executing the software module from the memory 203.

<3> FIG. 11 is a diagram illustrating a configuration example of the RU apparatus. In FIG. 11, an apparatus 300 includes an antenna array 301, a radio frequency transceiver 302, a network interface 303, a processor 304, and a memory 305. The RU apparatus 20 may have a configuration illustrated in FIG. 11. The RF transceiver 302 performs analog RF signal processing to communicate with UEs. The RF transceiver 302 may include a plurality of transceivers. The RF transceiver 302 is coupled with the antenna array 301 and the processor 304. The RF transceiver 302 receives modulation symbol data from the processor 304, generates a transmission RF signal, and provides the transmission RF signal to the antenna array 301. Also, the RF transceiver 302 generates a baseband reception signal based on a reception RF signal received by the antenna array 301, and provides the baseband reception signal to the processor 304. The RF transceiver 302 may include an analog beam former circuit for beam forming. The analog beam former circuit includes, for example, a plurality of phase shifters and a plurality of power amplifiers.

The network interface 303 is used to communicate with a network node (for example, the DU 10 and the SMO 30). The network interface 303 may include, for example, a network interface card (NIC) conforming to IEEE 802.3 series.

The processor 304 performs digital baseband signal processing (data plane processing) for radio communication and control plane processing. The processor 304 may include a plurality of processors. For example, the processor 304 may include a modem processor (for example, a digital signal processor (DSP)) that performs digital baseband signal processing and a protocol stack processor (for example, a central processing unit (CPU) or a micro processing unit (MPU)) that performs control plane processing.

The processor 304 may include a digital beam former module for beam forming. The digital beam former module may include a multiple input multiple output (MIMO) encoder and a precoder.

The memory 305 is constituted by a combination of a volatile memory and a nonvolatile memory. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 305 may include a storage disposed away from the processor 304. In this case, the processor 304 may access the memory 305 through the network interface 303 or an I/O interface (not illustrated).

The memory 305 may store one or more software module (computer program) including a group of instructions and data for performing processing by the RU apparatus 20 described in the example embodiments as described above. In some implementations, the processor 304 may be configured to perform the processing of the RU apparatus 20 described in the example embodiments as described above by reading and executing the software module from the memory 305.

The antenna array 301 may correspond to the above-described tx-array and rx-array.

<4> FIG. 12 is a diagram illustrating a configuration example of the SMO apparatus. In the example of FIG. 12, an SMO apparatus 400 is implemented as a computer system. The computer system 400 includes one or more processors 401, a memory 402, and a mass storage 403, which communicate with each other via a bus 407. The one or more processors 401 may include, for example, a central processing unit (CPU) or a graphics processing unit (GPU) or both the CPU and the GPU. The computer system 400 may include other devices, such as one or more output devices 404, one or more input devices 405, and one or more peripherals 406. The one or more peripherals 406 may include a modem, a network adapter, or any combination thereof.

One or both of the memory 402 and the mass storage 403 include a computer-readable medium storing one or more instruction sets. These instructions may be disposed partially or entirely in a memory within one or more processors 401. In a case where these instructions are executed in the one or more processors 401, these instructions cause the one or more processors 401 to provide the functions of the SMO apparatus 30 described in the above example embodiments.

Although the invention of the present application has been described above with reference to the example embodiments, the invention of the present application is not limited to the above. Various modifications that can be understood by those skilled in the art can be made to the configuration and details of the invention of the present application within the scope of the invention. Each example embodiment can be appropriately combined with another example embodiment.

Some or all of the above-described example embodiments may be described as in the following Supplementary Notes, but are not limited to the following Supplementary Notes.

### (Supplementary Note 1)

A radio unit (RU) apparatus including:
at least one memory; and
at least one processor coupled to the at least one memory, in which
the at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes any one or both of
information indicating that at least one of a control/user (C/U)-plane, a synchronization (S)-plane, a management (M)-plane, and components of the RU apparatus is stopped in a case where a power-state of the RU apparatus is sleeping, and
information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

### (Supplementary Note 2)

The RU apparatus according to Supplementary Note 1, in which the component includes at least one of a digital device part and an analog device part.

### (Supplementary Note 3)

The RU apparatus according to Supplementary Note 2, in which the digital device part includes at least one of a field programmable gate array (FPGA), a complex programmable logic device (CPLD), an application specific integrated circuit (ASIC), a processor, and a network interface.

### (Supplementary Note 4)

The RU apparatus according to Supplementary Note 2, in which the analog device part is a power amplifier (PA).

### (Supplementary Note 5)

A radio unit (RU) apparatus including:
at least one memory; and
at least one processor coupled to the at least one memory, in which
the at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes any one or both of
information indicating whether or not a voltage of the RU apparatus can be lowered in a case where a power-state of the RU apparatus is sleeping, and
information indicating whether or not a voltage of the RU apparatus can be lowered in a case where a value of an active parameter of tx/rx-array-carriers of the RU apparatus is SLEEP or DISABLED.

### (Supplementary Note 6)

The RU apparatus according to Supplementary Note 5, in which the lowering of the voltage of the RU apparatus includes at least one of lowering antenna transmit power of the RU apparatus, stopping a power amplifier (PA) of the RU apparatus, and stopping power supply from the RU apparatus to an external device connected to the RU apparatus.

### (Supplementary Note 7)

A radio unit (RU) apparatus including:
at least one memory; and
at least one processor coupled to the at least one memory, in which
the at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes information indicating whether or not the RU apparatus transmits any one or both of Notification indicating that a state of tx/rx-array-carriers is Disabled in a case where a power-state of the RU apparatus is sleeping, and Notification indicating that the state of the tx/rx-array-carriers is Ready in a case where the power-state of the RU apparatus is Awake.

### (Supplementary Note 8)

A radio unit (RU) apparatus including:
at least one memory; and
at least one processor coupled to the at least one memory, in which
the at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes information indicating that, in a case where a power-state of the RU apparatus is Awake, an active parameter of tx/rx-array-carriers needs to be reset to Active by the RU controller.

### (Supplementary Note 9)

A control apparatus including:
at least one memory; and
at least one processor coupled to the at least one memory, in which
the at least one processor is configured to transmit, to a radio unit (RU) apparatus, a remote procedure call (RPC) message that is based on a network configuration protocol (NETCONF) and indicates configuration edit (edit-config), and
the RPC message includes any one or both of
configuration information indicating that at least one of a control/user (C/U)-plane, a synchronization (S)-plane, a management (M)-plane, and components of the RU apparatus is stopped in a case where a power-state of the RU apparatus is sleeping, and
configuration information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

### (Supplementary Note 10)

The control apparatus according to Supplementary Note 9, in which the component includes at least one of a digital device part and an analog device part.

### (Supplementary Note 11)

The control apparatus according to Supplementary Note 10, in which the digital device part includes at least one of a field programmable gate array (FPGA), a complex programmable logic device (CPLD), an application specific integrated circuit (ASIC), a processor, and a network interface.

### (Supplementary Note 12)

The control apparatus according to Supplementary Note 10, in which the analog device part is a power amplifier (PA).

### (Supplementary Note 13)

A control apparatus including:
at least one memory; and
at least one processor coupled to the at least one memory, in which
the at least one processor is configured to transmit, to a radio unit (RU) apparatus, a remote procedure call (RPC) message that is based on a network configuration protocol (NETCONF) and indicates configuration edit (edit-config), and
the RPC message includes any one or both of
configuration information indicating that a voltage of the RU apparatus is lowered in a case where a power-state of the RU apparatus is sleeping, and
configuration information indicating that the voltage of the RU apparatus is lowered in a case where a value of an active parameter of tx/rx-array-carriers of the RU apparatus is SLEEP or DISABLED.

### (Supplementary Note 14)

The control apparatus according to Supplementary Note 13, in which the lowering of the voltage of the RU apparatus includes at least one of lowering antenna transmit power of the RU apparatus, stopping a power amplifier (PA) of the RU apparatus, and stopping power supply from the RU apparatus to an external device connected to the RU apparatus.

### (Supplementary Note 15)

A method performed by a radio unit (RU) apparatus, the method including:
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message,
in which the RPC reply message includes any one or both of
information indicating that at least one of a control/user (C/U)-plane, a synchronization (S)-plane, a management (M)-plane, and components of the RU apparatus is stopped in a case where a power-state of the RU apparatus is sleeping, and
information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

### (Supplementary Note 16)

The method according to Supplementary Note 15, in which the component includes at least one of a digital device part and an analog device part.

### (Supplementary Note 17)

The method according to Supplementary Note 16, in which the digital device part includes at least one of a field programmable gate array (FPGA), a complex programmable logic device (CPLD), an application specific integrated circuit (ASIC), a processor, and a network interface.

### (Supplementary Note 18)

The method according to Supplementary Note 16, in which the analog device part is a power amplifier (PA).

### (Supplementary Note 19)

A method performed by a radio unit (RU) apparatus, the method including:
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message,
in which the RPC reply message includes any one or both of
information indicating whether or not a voltage of the RU apparatus can be lowered in a case where a power-state of the RU apparatus is sleeping, and
information indicating whether or not a voltage of the RU apparatus can be lowered in a case where a value of an active parameter of tx/rx-array-carriers of the RU apparatus is SLEEP or DISABLED.

### (Supplementary Note 20)

The method according to Supplementary Note 19, in which the lowering of the voltage of the RU apparatus includes at least one of lowering antenna transmit power of the RU apparatus, stopping a power amplifier (PA) of the RU apparatus, and stopping power supply from the RU apparatus to an external device connected to the RU apparatus.

### (Supplementary Note 21)

A method performed by a radio unit (RU) apparatus, the method including:
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message,
in which the RPC reply message includes information indicating whether or not the RU apparatus transmits any one or both of Notification indicating that a state of tx/rx-array-carriers is Disabled in a case where a power-state of the RU apparatus is sleeping, and Notification indicating that the state of the tx/rx-array-carriers is Ready in a case where the power-state of the RU apparatus is Awake.

### (Supplementary Note 22)

A method performed by a radio unit (RU) apparatus, the method including:
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message,
in which the RPC reply message includes information indicating that, in a case where a power-state of the RU apparatus is Awake, an active parameter of tx/rx-array-carriers needs to be reset to Active by the RU controller.

### (Supplementary Note 23)

A method performed by a control apparatus, the method including: transmitting, to a radio unit (RU) apparatus, a remote procedure call (RPC) message that is based on a network configuration protocol (NETCONF) and indicates configuration edit (edit-config),
in which the RPC message includes any one or both of
configuration information indicating that at least one of a control/user (C/U)-plane, a synchronization (S)-plane, a management (M)-plane, and components of the RU apparatus is stopped in a case where a power-state of the RU apparatus is sleeping, and
configuration information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

### (Supplementary Note 24)

The method according to Supplementary Note 23, in which the component includes at least one of a digital device part and an analog device part.

### (Supplementary Note 25)

The method according to Supplementary Note 24, in which the digital device part includes at least one of a field programmable gate array (FPGA), a complex programmable logic device (CPLD), an application specific integrated circuit (ASIC), a processor, and a network interface.

### (Supplementary Note 26)

The method according to Supplementary Note 24, in which the analog device part is a power amplifier (PA).

### (Supplementary Note 27)

A method performed by a control apparatus, the method including: transmitting, to a radio unit (RU) apparatus, a remote procedure call (RPC) message that is based on a network configuration protocol (NETCONF) and indicates configuration edit (edit-config),
in which the RPC message includes any one or both of
configuration information indicating that a voltage of the RU apparatus is lowered in a case where a power-state of the RU apparatus is sleeping, and
configuration information indicating that the voltage of the RU apparatus is lowered in a case where a value of an active parameter of tx/rx-array-carriers of the RU apparatus is SLEEP or DISABLED.

### (Supplementary Note 28)

The method according to Supplementary Note 27, in which the lowering of the voltage of the RU apparatus includes at least one of lowering antenna transmit power of the RU apparatus, stopping a power amplifier (PA) of the RU apparatus, and stopping power supply from the RU apparatus to an external device connected to the RU apparatus.

This application claims priority based on Japanese Patent Application No. 2022-119669 filed on Jul. 27, 2022, the entire disclosure of which is incorporated herein.

### REFERENCE SIGNS LIST

1 SYSTEM
10 DU APPARATUS
11 CONTROL UNIT (CONTROL APPARATUS)
20 RU APPARATUS
21 CONTROL UNIT
30 SMO APPARATUS

What is claimed is:

1. A radio unit (RU) apparatus comprising:
at least one memory; and
at least one processor coupled to the at least one memory, wherein
the at least one processor is configured to
receive, from an RU controller, a remote procedure call (RPC) message that is based on a network configuration protocol (NETCONF) and indicates retrieval (get or get-config), and
transmit an RPC reply (rpc-reply) message to the RU controller in response to the RPC message, and
the RPC reply message includes any one or both of
information indicating that at least one of a control/user (C/U)-plane, a synchronization (S)-plane, a management (M)-plane, and components of the RU apparatus is stopped in a case where a power-state of the RU apparatus is sleeping, and
information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

2-14. (canceled)

15. A method performed by a radio unit (RU) apparatus, the method comprising:
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message,
wherein the RPC reply message includes any one or both of
information indicating that at least one of a control/user (C/U)-plane, a synchronization (S)-plane, a management (M)-plane, and components of the RU apparatus is stopped in a case where a power-state of the RU apparatus is sleeping, and
information indicating that at least one of the control/user (C/U)-plane, the synchronization (S)-plane, the management (M)-plane, and the components of the RU apparatus is stopped in a case where a value of an active parameter of tx/rx-array-carriers of the RU apparatus is SLEEP or DISABLED.

16. The method according to claim 15, wherein the component includes at least one of a digital device part and an analog device part.

17. The method according to claim 16, wherein the digital device part includes at least one of a field programmable gate array (FPGA), a complex programmable logic device (CPLD), an application specific integrated circuit (ASIC), a processor, and a network interface.

18. The method according to claim 16, wherein the analog device part is a power amplifier (PA).

19. A method performed by a radio unit (RU) apparatus, the method comprising:
receiving, from an RU controller, a remote procedure call (RPC) message that is based on a network configuration protocol (NETCONF) and indicates retrieval (get or get-config); and
transmitting an RPC reply (rpc-reply) message to the RU controller in response to the RPC message,
wherein the RPC reply message includes any one or both of
information indicating whether or not a voltage of the RU apparatus can be lowered in a case where a power-state of the RU apparatus is sleeping, and
information indicating whether or not a voltage of the RU apparatus can be lowered in a case where a value of an active parameter of tx/rx-array-carriers of the RU apparatus is SLEEP or DISABLED.

20. The method according to claim 19, wherein the lowering of the voltage of the RU apparatus includes at least one of lowering antenna transmission power of the RU apparatus, stopping a power amplifier (PA) of the RU apparatus, and stopping power supply from the RU apparatus to an external device connected to the RU apparatus.

21-28. (canceled)
